(19) United States
(12) Patent Application Publication
(10) Pub. No.: US 2024/0344886 A1
(43) Pub. Date: Oct. 17, 2024

(54) A MONITORING SYSTEM AND METHOD FOR IDENTIFYING OBJECTS

(71) Applicant: Continental Automotive Technologies GmbH, Hannover (DE)

(72) Inventor: Weiquan Cong, Singapore (SG)

(73) Assignee: Continental Automotive Technologies GmbH, Hannover (DE)

(21) Appl. No.: 18/682,888

(22) PCT Filed: Jun. 29, 2022
(86) PCT No.: PCT/EP2022/067878

§ 371 Date: Feb. 9, 2024

(30) Foreign Application Priority Data
Aug. 12, 2021 (GB) 2111571.2

(51) Int. Cl. G01J 3/28; B60R 21/015; G01J 5/00; G06V 20/59; G06V 40/10; H04N 23/56

(52) U.S. Cl. CPC G01J 3/2823; B60R 21/01538; G01J 5/0025; G06V 20/597; G06V 40/10; H04N 23/56

(57) ABSTRACT

A monitoring system for identifying objects in a passenger cabin of a motor vehicle is disclosed. The monitoring system includes an imaging module to capture multiple spectral images. The imaging module having a plurality of light sources for emitting light rays at different spectral bandwidth. The monitoring system further includes a processing unit operable to combine light rays emitted from at least two of the plurality of light sources into a combined light ray operating in a single wavelength, such that the imaging module is operable to capture a multiple spectral image of a passenger cabin for object identification. A method of identifying objections in a passenger cabin of a motor vehicle base on a multiple spectral image captured by a monitoring disclosed herein, a computer software product and a non-transitory medium prestored with the same is also disclosed.

### CROSS REFERENCE TO RELATED APPLICATIONS

This US patent application claims the benefit of PCT patent application No. PCT/EP2022/067878, filed Jun. 29, 2022, which claims the benefit of GB patent application No. 2111571.2, filed Aug. 12, 2021, both of which are hereby incorporated by reference.

### TECHNICAL FIELD

This disclosure relates to a monitoring system for use in a passenger cabin of a motor vehicle, and more in particular, a monitoring system for identifying objects within a passenger cabin of a motor vehicle.

### BACKGROUND

Driver monitoring systems are usually implemented in-cabin or mounted in a dashboard area of a motor vehicle, to monitor status of a driver, for detection of driver's distraction, fatigue and/or health condition, such that advance driving functions, for example safety warning or autonomous driving function may be triggered, to ensure safety of drivers on the road.

In a best-case scenario, a camera module of a monitoring system captures clear images that allows the monitoring system to process and determine status of the driver. However, details of the physical characteristics of drivers requires in-depth analysis. Conventional monitoring system uses near-infrared (NIR) lighting at either 850 nm or 940 nm, which provides a very narrow bandwidth with limited spectral information. Apart from the challenge of recognizing physical characteristics of the driver, which often involves analyzing complex or multiple reflections appearing on images captured, due to different derma layers of human skin and contour of a driver's face, it may also be challenging to differentiate vehicle seat fabrics from driver's clothing. This means that driver monitoring systems will require very extensive image recognition algorithms to analyses images captured under such lighting conditions.

Conventional solutions used in agriculture uses cameras that is to use optical coatings or filters to achieve cameras that captures multiple-band images. Nonetheless, such solutions are expensive and requires complex manufacturing process to produce miniature cameras or image sensors that are suitable for mounting on a dashboard area of a motor vehicle.

There is, therefore, a need to provide a monitoring system and method for identifying objections within a passenger cabin of a motor vehicle, which at least ameliorate some of the problems discussed above. Furthermore, other desirable features and characteristics will become apparent from the subsequent detailed description and the appended claims, taking in conjunction with the accompanying drawings and this background of the disclosure.

### SUMMARY

The objective of this disclosure is solved by a monitoring system for identifying objects in a passenger cabin of a motor vehicle comprising an imaging module operable to capture multiple spectral images, the imaging module comprising a plurality of light sources operable to emit light rays, and a processing unit, the processing unit operable to switch on/switch off each of the plurality of light sources, wherein each of the plurality of light sources is operable in a different spectral bandwidth, and the processing unit is configured to operate the plurality of light sources so that emitted light rays from at least two of the plurality of light sources to form a combined light ray with a single wavelength, such that the imaging module is operable to capture multiple spectral images of a passenger cabin, wherein the multiple spectral images comprise at least the combined light ray.

The above described aspect of this disclosure yields a monitoring system for identifying objects within a passenger cabin of a motor vehicle. This is achieved by combining at least two light rays from at least two light sources operating at different spectral bandwidths into a combined light ray having a single wavelength, such that a single light ray with a wider and/or multiple wavelengths is achieved. Consequently, images captured includes the combined light ray derived from light rays operating at different spectral bandwidths, thus producing multiple spectral images, without having to replace cameras or imaging device with multiple filters or coatings.

In one embodiment of the monitoring system as described above, the processing unit is operable to switch on at least two of the plurality of light sources sequentially, to combine emitted light rays from at least two of the plurality of light sources, such that the combined light rays having a single wavelength.

The above aspect of this disclosure is to switch on at least two light sources operating in different spectral bandwidth sequentially such that each time only one light source operating in one bandwidth is switched on at a time or one after the other. Consequently, the multiple spectral images captured by the imaging module shows objects captured in different spectral bandwidth or different ranges of wavelengths. This feature allows different types of objects appearing in the multiple spectral images captured to be identified or recognized.

In one embodiment of the monitoring system as described above, the multiple spectral images captured by the imaging module comprises at least a first point of reflectance within a first spectral bandwidth, and a second point of reflectance within a second spectral bandwidth.

The above aspect of this disclosure is to yield multiple spectral images showing at least two point of reflectance, of which each point of reflectance being captured within a different spectral bandwidth, such that in-depth analysis of the object captured in the multiple spectral images may be carried out.

In one embodiment of the monitoring system as described above, the processing unit is operable to switch on at least two of the plurality of light sources simultaneously, to combine emitted light rays from at least two of the plurality of light sources, such that the combined light ray has a single wavelength.

The above aspect of this disclosure is to switch on at least two light sources operating in different spectral bandwidth simultaneously or at the same time. This feature allows different materials within a passenger cabin to be captured in a single multiple spectral image having different reflectance at different bandwidth. Consequently, a reflectance difference may be easily identified in the multiple spectral images captured by the imaging module.

In one embodiment of the monitoring system as described above, further comprises an analyzer module operable to determine an object in the multiple spectral images captured.

The above aspect of this disclosure is to execute object identification process, by way of an analyzer module, to determine different types of objects in the multiple spectral images captured by the imaging module.

In one embodiment of the monitoring system as described above, the analyzer module is operable to retrieve a reflectance curve prestored in a memory, and compare the multiple spectral image captured against the reflectance curve retrieved, to identify a pixel intensity difference between the reflectance curve prestored in the memory compared to the multiple spectral image captured.

The above aspect of this disclosure is to compare the multiple spectral image captured by the imaging module with a reflectance curve prestored in a memory of the analyzer module, such that a pixel intensity difference between the multiple spectral image captured and the reflectance curve retrieved from memory may be identified.

In one embodiment of the monitoring system as described above, in response to the pixel intensity difference identified is a predetermined value, the analyzer module is operable to determine if the object in the multiple spectral image captured is an organ of a human.

The above aspect of this disclosure is to yield identification or recognition of an object captured in the multiple spectral image, of which if based upon the comparison of the pixel intensity difference is a predetermined value, the analyzer module determines the object captured in the multiple spectral image is an organ of a human.

In one embodiment of the monitoring system as described above, the organ of the human is a skin of the human.

The above aspect of this disclosure is to identify or recognize an organ of a human as a human's skin.

In one embodiment of the monitoring system as described above, the analyzer module is operable to retrieve a reflectance curve prestored in a memory, sample at least one point of reflectance within a spectral range of the multiple spectral image captured, and compare the at least one point of reflectance sampled against a spectral range on the reflectance curve retrieved, the spectral range being a same spectral range as the spectral range sampled, to identify a type of object in the multiple spectral image captured by the imaging module.

The above aspect of this disclosure is to apply a sampling process, by selecting at least one point of reflectance from a spectral range of the multiple spectral image captured by the imaging module and compare the at least one point of reflectance against a reflectance curve retrieved from memory of the analyzer module. This feature allows the analyzer module to identify at least one type of object within a selected spectral bandwidth range.

In one embodiment of the monitoring system as described above, the analyzer module is operable to sample the first point of reflectance and the second point of reflectance against the reflectance curve retrieved.

The above aspect of this disclosure is to select at least two points of reflectance to from the multiple spectral image to be compared against the reflectance curved retrieve from memory. This feature allows the analyzer module to identify objects in the multiple spectral image in different spectral bandwidth.

In one embodiment of the monitoring system as described above, the first point of reflectance and the second point of reflectance is within a spectral range of the single wavelength of the combined light ray.

In one embodiment of the monitoring system as described above, the single wavelength of the combined light ray is within a near-infrared wavelength.

The above aspect of this disclosure is to capture multiple spectral images within near-infrared wavelength. This feature is of particularly of advantage for vehicular applications.

In one embodiment of the monitoring system as described above, the imaging module further comprises a driver for driving each of the plurality of light sources.

The above aspect of this disclosure is to yield an independent imaging module that comprises a driver to switch on or switch off the plurality of light sources.

In one embodiment of the monitoring system as described above, the processing unit is a binary spatial partitioning.

The above aspect of this disclosure is to yield a processing unit configured to implement subdivision of the monitoring system, such that the imaging module may be a sub-system of a main monitoring system. This feature allows execution of a computer software product for auxiliary imaging module or device.

In one embodiment of the monitoring system as described above, the processing unit is a host controller in electronic communication with the imaging module.

The above aspect of this disclosure is to yield a processing unit configured to implement subdivision of the monitoring system by transmitting data information over electronic communication to sub-systems, i.e. the imaging module.

In one embodiment of the monitoring system as described above, the processing unit comprises the analyzer module.

The above aspect of this disclosure is to yield a processing unit configured to implement or execute functions of the analyzer module as disclosed herein.

In one embodiment of the monitoring system as described above, the reflectance curve comprises spectral measurements of different objects.

The above aspect of this disclosure is to yield a reflectance curve which covers spectral measurements of different objects that are typically found within a passenger cabin, for use as a reference for object identification.

The objective of this disclosure is solved by a method of identifying objects in a passenger cabin of a motor vehicle comprising executing a set of instructions prestored in a memory of a processing unit for combining light rays emitting from at least two light sources, each light source operating at a different spectral bandwidth, into a combined light ray having a single wavelength, capturing a multiple spectral image of a passenger cabin, and identifying an object captured in the multiple spectral image.

The above described aspect of this disclosure yields a method of identifying objects within a passenger cabin of a motor vehicle, by capturing a multiple spectral image using an imaging module with at least two light sources, each light sources operating at a different spectral bandwidth.

In one embodiment of the method of identifying objects within a passenger cabin of a motor vehicle as described above, the set of instructions for combining light rays emitted from at least two light sources into a combined light ray having a single wavelength comprises switching on the at least two light sources sequentially, or switching on the at least two light sources simultaneously.

The above aspect of this disclosure is to switch on at least two light sources operating in different spectral bandwidth sequentially such that each time only one light source operating in one bandwidth is switched on at a time or one after the other. Consequently, the multiple spectral images captured by the imaging module shows objects captured in different spectral bandwidth or different ranges of wavelengths. This feature allows different types of objects appearing in the multiple spectral images captured to be identified or recognized. In contrast, the advantage of switching on at least two light sources operating in different spectral bandwidth simultaneously or at the same time allows different materials within a passenger cabin to be captured in a single multiple spectral image having different reflectance at different bandwidth. Consequently, a reflectance difference may be easily identified in the multiple spectral images captured by the imaging module when the plurality of light sources are switched on simultaneously.

In one embodiment of the method of identifying objects within a passenger cabin of a motor vehicle as described above, further comprises comparing at least two points of reflectance of the multiple spectral image captured against a reflectance curve retrieved from a memory of a processing unit, for identification of a type of object captured in the multiple spectral image.

The above aspect of this disclosure is an object identification process, for identifying one or more types of objects captured in the multiple spectral images by comparing at least two points of reference of the multiple spectral images against a reflectance curve prestored in a memory.

In one embodiment of the method of identifying objects within a passenger cabin of a motor vehicle as described above, further comprises identifying a pixel intensity difference between the at least one points of reflectance of the multiple spectral image captured against the at least two points of reflectance the reflectance curve retrieved, and determining the object is an organ of a human in response to the pixel intensity difference is a predetermined value.

The above aspect of this disclosure is to identify an object captured in the multiple spectral images is an organ of a human.

In one embodiment of the method of identifying objects within a passenger cabin of a motor vehicle as described above, further comprises sampling at least one point of reflectance within a spectral range of the multiple spectral image captured, and comparing the at least one point of reflectance sampled against at least one point of the reflectance curve retrieved within a spectral range the same as the spectral range sampled, for identifying a type of object in the multiple spectral image captured.

The above aspect of this disclosure is to apply a sampling process, by selecting at least one point of reflectance from a spectral range of the multiple spectral image captured by the imaging module and compare the at least one point of reflectance against a reflectance curve retrieved from memory of the analyzer module. This feature allows the analyzer module to identify at least one type of object within a selected spectral bandwidth range.

In one embodiment of the method of identifying objects within a passenger cabin of a motor vehicle as described above, wherein the objective of this disclosure is solved by a computer software product comprising a non-transitory storage medium readable by a processing unit, the non-transitory storage mediums having stored thereon a set of instructions to cause a system as described above.

This aspect of the disclosure is to yield a computer software product that may be prestored in a non-transitory storage medium, to execute a set of instructions for capturing multiple spectral images within a passenger cabin of a motor vehicle and to identity objects captured in the multiple spectral images.

The objective of this disclosure is solved by a non-transitory medium having stored thereon the computer software product as described above.

This aspect of the disclosure is to yield a non-transitory medium configured to execute a set of instructions for capturing multiple spectral images within a passenger cabin of a motor vehicle and to identity objects captured in the multiple spectral images.

### BRIEF DESCRIPTION OF DRAWINGS

The objects and aspects of this disclosure will become apparent from the following description of embodiments with reference to the accompanying drawings in which:

FIG. 1 shows a schematic diagram of a monitoring system in accordance with an embodiment;

FIG. 2 shows an exemplary reflectance curve in accordance with an embodiment;

FIG. 3A shows a flowchart for an object identification process in accordance with an embodiment;

FIG. 3B shows a flowchart for an object identification process in accordance with an embodiment; and

FIG. 3C shows a flowchart for an object identification process in accordance with an embodiment.

In various embodiments described by reference to the above figures, like reference signs refer to like components in several perspective views and/or configurations.

### DETAILED DESCRIPTION

The following detailed description is merely exemplary in nature and is not intended to limit the disclosure or the application and uses of the disclosure. Furthermore, there is no intention to be bound by any theory presented in the preceding background of the disclosure or the following detailed description. It is the intent of this disclosure to present a monitoring system and method for identifying objects in a passenger cabin of a motor vehicle.

Hereinafter, the term “point of reflectance” refers to a point or spot where a reflection occurs, for identification of coordinates of the reflected point in terms of horizontal and vertical direction.

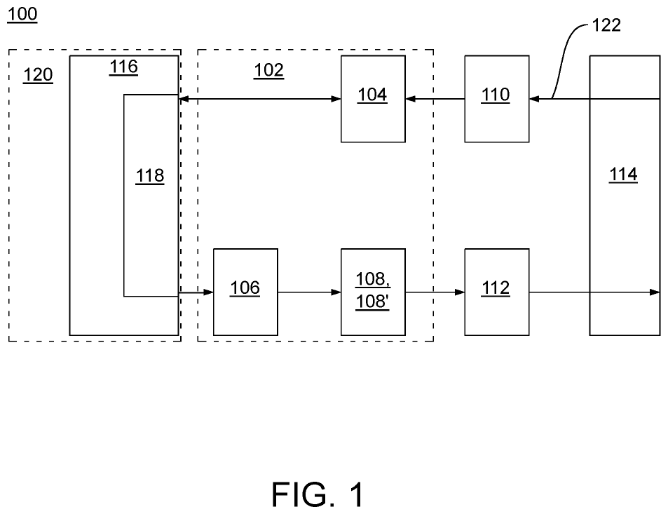

Turning now to the accompanying drawings, FIG. 1 shows a schematic diagram of a monitoring system 100 in accordance with an embodiment. The monitoring system 100 includes an imaging module 102 to capture images and a host controller 120 to operate the imaging module 102. The image module 102 further comprises an image sensor 104 to receive sensing data capture within a field of view (FOV) of the imaging module 102 and a plurality of light sources 108, 108′. The imaging module 102 may include a driver 106 to drive the plurality of light sources 108, 108′ to switch ON or switch OFF. If such configuration is preferred, the processing unit 116 may execute instruction to request the driver 106 to switch ON or switch OFF the plurality of light sources 108, 108′.

The host controller 120 may comprises a processing unit 116 and an analyzer module 118. The processing unit 116 function as a computer software program or product, to execute instructions to technical elements within the monitoring system 100. The processing unit 116 may include a memory. The term “memory” should be interpreted broadly to encompass any electronic component capable of storing electronic information. The term “memory” may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor. As shown in FIG. 1, light rays 122 which include information of object, is transmitted through a cover 114 for monitoring system and image sensor lens 110 before being captured by the image sensor 104.

Optionally, the imaging module 102 includes image sensor lens 110 which defines a FOV of the imaging module 102 and at least one auxiliary optics 112 to tune and achieve uniformity of lighting. Optionally, an infrared (IR) cover 114 may be used to cover the imaging module 102. The IR cover 114 function as a long pass filter, to filter out light rays within the visible spectrum and allow near infrared (NIR) light rays to pass through. This is to establish a relatively controlled ambient lighting environment for vehicular applications.

In an embodiment, the processing unit 116 is operable to execute instructions to drive the plurality of light sources 108, 108′ to switch ON or switch OFF, such that emitted light rays from at least two sources of the plurality of light sources 108, 108′ forms a combined light ray with a single wavelength. The plurality of light sources 108, 108′ may be operable in different spectral bandwidth. By way of an example, a first light source 108 may be operating at 850 nm and a second light source 108′ may be operating at 940 nm. It shall be understood by a skilled practitioner, it is possible to combine more than two light sources operating in different spectral bandwidth to achieve the same technical effect. The combined light ray with a single bandwidth enables the imaging module 102 to capture multiple spectral images comprising at least the combined light ray.

In an embodiment, the processing unit 116 is operable to switch ON at least two of the plurality of light sources 108, 108′ sequentially, to combine emitted light rays from at least two of the plurality of light sources 108, 108′, such that the combined light rays having a single wavelength. The aforesaid configuration switches the at least two light sources 108, 108′ operating in different spectral bandwidth sequentially such that each time only one light source operating in one bandwidth is switched on at a time or one after the other. Consequently, the multiple spectral images captured by the imaging module 102 shows objects captured in different spectral bandwidth or different ranges of wavelengths. This feature allows different types of objects appearing in the multiple spectral images captured to be identified or recognized.

In this embodiment, the multiple spectral images captured by the imaging module 102 comprises at least a first point of reflectance within a first spectral bandwidth and a second point of reflectance within a second spectral bandwidth. In this scenario, the first point of reflectance may be within a first spectral bandwidth, i.e. 850 nm while the second point of reflectance is within the spectral bandwidth, i.e. 940 nm. As explained above, the term ‘point of reflectance’ refers to a spot where a reflection occurs, for identification of coordinates of the reflected point in terms of horizontal and vertical direction. Having two or more points of reflectance captured in a multiple spectral image is to facilitate object identification processing, to identify types of object captured in the multiple spectral images.

Different types of objects or surface causes reflection of light rays to behave differently. In particular, the reflectance spectrum of human skin is very complex, due to nature of human skin, which may vary according to age, ethnic group, skin layer structure, facial characteristics (eg. nose, lip, eyes) and so forth. As such, the ability to identify different types of objects, in particular in a passenger cabin of a motor vehicle is extremely challenging.

As disclosed herein, an analyzer module 118 executes a set of steps to determine an object in the multiple spectral images captured. In the embodiment as described above, the multiple spectral image is captured when the plurality of light sources 108, 108′ is captured sequentially. The multiple spectral image captured by the imaging module 102 shows the first point of reflectance is within a first spectral bandwidth and the second point of reflectance is within a spectral bandwidth. This multiple spectral image captured may be checked against a reflectance curve prestored in memory. The memory may be embedded within the analyzer module 118, the processing unit 116 or the host control 120.

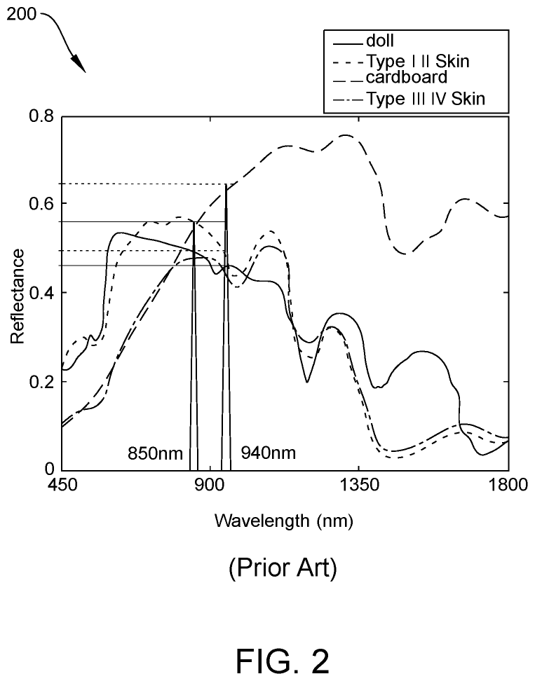

An exemplary reflectance curve 200 is as shown in FIG. 2 of the accompanying drawings. As may be seen from FIG. 2, the reflectance curve 200 comprises reflectance curves for different types of objects, materials or textures. For clarity, the exemplary reflectance curve 200 shown in FIG. 2 is a reference model for implementing the inventive concept of this disclosure. It shall be understood by a skilled practitioner, other forms of reflectance curve for different types of skin and/or surface within a passenger cabin or other types of A sampling process may be applied, by selecting a first point of reflectance and a second point from the multiple spectral images capture, to be benchmark or compared against the reflectance curve 200 for object identification process, to identify different types of objects within the passenger cabin. As explained earlier, a technical advantage of sequentially switching ON the plurality of light sources 108, 108′, controls the ambient lighting condition and as such, objects within certain spectral bandwidth points will be captured. In this embodiment, it may be necessary to adjust or optimize exposure settings, current settings or gain settings to increase ambient lighting.

In another embodiment, the processing unit 116 is operable to switch on at least two of the plurality of light sources 108, 108′ simultaneously, to combine emitted light rays from at least two of the plurality of light sources 108, 108′, such that the combined light ray has a single wavelength. Since the multiple spectral image captured by the imaging module 102 comprises the combined light rays, point of reflectance of different objects or different materials is enhanced, since different reflectance at different spectral bandwidth are captured in a single wavelength, the differences show up in the multiple spectral image captured by the imaging module 102. Consequently, the analyzer module 118 executes instruction to determine the objects, by identifying a pixel intensity difference between different areas of the multiple spectral image. In an exemplary embodiment, the pixel intensity difference is determined by comparing the reflectance curve prestored in memory against the multiple spectral image captured. The pixel intensity difference may be a predetermined value, for example an amount of reflectance of a human skin. Determination of a pixel intensity difference enables the analyzer module 118 to identify an organ of a human sitting within a passenger cabin, of which the organ is a skin of the human. Different types of skin may be categorised according a predetermined value.

In all of the embodiments described herein, the single wavelength of the combined light ray is preferably operating in a near infrared (NIR) wavelength.

In all of the embodiments described herein, the processing unit 116 may function as a binary spatial partitioning (BSP).

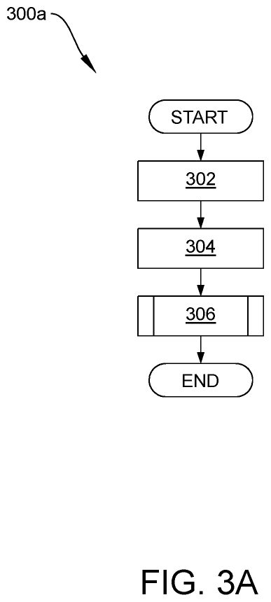

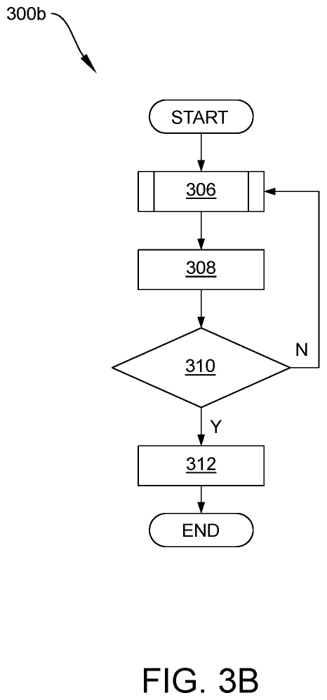

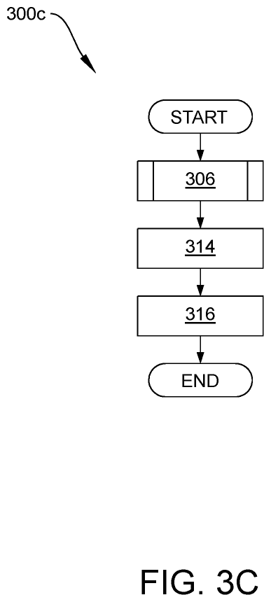

In an embodiment, the processing unit 116 may include a set of instructions prestored in memory, for identifying objects within a passenger cabin of a motor vehicle. FIG. 3A shows a flowchart 300a for object identification using the monitoring system 100 as disclosed herein. In step 302, the method includes executing 302, by way of a processing unit, a set of instructions prestored in a memory, for combining light rays emitting from at least two light sources, each light source operating at a different spectral bandwidth, into a combined light ray having a single wavelength. The set of instructions for combing light rays emitting from at least two light sources into a combined light ray having a single wavelength may include switching on the at least two or more light sources sequentially. The set of instructions for combing light rays emitting from at least two light sources into a combined light ray having a single wavelength may further include switching on the at least two or more light sources simultaneously. Switching on the plurality of light sources of the imaging module sequentially or simultaneously as explained above is re-iterated.

In a next step 304, the set of instructions includes a sequence of capturing one or more multiple spectral image of a passenger cabin, by way of an imaging module of a monitoring system. Further processing of the one or more multiple spectral image captured may be executed in a next step 306, which includes an object identification process.

Referring to FIG. 3B which shows a flowchart 300b, in a step 306, a sequence of comparing at least two points of reflectance of the multiple spectral image captured against a reflectance curve is executed by an analyzer module. The reflectance curve comprises information of reflectance curve for different types of objects, surface or materials which may be present within a passenger cabin. The reflectance curve may be prestored in a memory of the analyzer module or the processing unit and retrieved by the analyzer module for purposes of step 306, to identify a type of object captured in the multiple spectral image.

In a next step 310, the set of instructions include a sequence of identifying a pixel intensity. This function is executed by the analyzer module 118, which is operable to retrieve a reflectance curve prestored in memory. The sequence includes a sampling process, to sample at least one point of reflectance within a spectral range of the multiple spectral image captured. The at least one point of reflectance sampled is compared against a spectral range on the reflectance curve retrieved. Through the sampling process, this step helps to identify a type of object in the multiple spectral image captured. If at step 310, it is determined by the analyzer module there is a difference in pixel intensity, a next step 312 is executed to identify the pixel intensity difference indicates an organ of a human and more in particular, a skin of a human, thus determining an object captured in the multiple spectral image is part of a human or a passenger in the passenger cabin.

On the other hand, if at step 310 the analyzer module determines there is no difference in pixel intensity between the point of reflectance from the multiple spectral image and the spectral range of the reflectance curve retrieved, the next sequence goes back to step 306 for further object identification process. Further object identification process may include step 314, to execute sampling at least one point of reflectance within a spectral range of the multiple spectral image captured. In the next step 316, the set of instructions include executing a sequence of comparing the at least one point of reflectance sampled against at least one point of the reflectance curve retrieved from memory. This sequence helps to identify objects which does not fall within step 310, to identify objects captured other than skin of human, for example fabric of vehicle seat.

Thus, it may be seen that a monitoring system and method of identifying objects within a passenger cabin having the advantage of capturing multiple spectral images for identifying different types of objects with different reflectance has been provided. More advantageously, a computer software product may be implemented with the monitoring system as disclosed herein, to carry out the object identification process. While exemplary embodiments have been presented in the foregoing detailed description of the disclosure, it should be appreciated that a vast number of variation exist.

It should further be appreciated that the exemplary embodiments are only examples, and are not intended to limit the scope, applicability, operation or configuration of the disclosure in any way.

1. A monitoring system for identifying objects in a passenger cabin of a motor vehicle comprising:
an imaging module operable to capture multiple spectral images, the imaging module comprising
a plurality of light sources operable to emit light rays; and
a processing unit, the processing unit operable to switch on/switch off each of the plurality of light sources,
wherein
each of the plurality of light sources is operable in
a different spectral bandwidth;
and wherein
the processing unit is configured to operate the plurality of light sources so that
emitted light rays from at least two of the plurality of light sources to form a combined light ray with a single wavelength,
such that the imaging module is operable to capture multiple spectral images of a passenger cabin, wherein the multiple spectral images comprise at least the combined light ray.

2. The monitoring system of claim 1, wherein the processing unit is operable to
switch on at least two of the plurality of light sources sequentially, to combine emitted light rays from at least two of the plurality of light sources,
such that the combined light rays having a single wavelength.

3. The monitoring system of claim 1, wherein the multiple spectral images captured by the imaging module comprises at least
a first point of reflectance within a first spectral bandwidth, and
a second point of reflectance within a second spectral bandwidth.

4. The monitoring system of claim 1, wherein the processing unit is operable to
switch on at least two of the plurality of light sources simultaneously, to combine emitted light rays from at least two of the plurality of light sources,
such that the combined light ray has a single wavelength.

5. The monitoring system of claim 1, further comprising
an analyzer module (118) operable to determine an object in the multiple spectral images captured.

6. The monitoring system of claim 5, wherein the analyzer module is operable to
retrieve a reflectance curve prestored in a memory, and
compare the multiple spectral image captured against the reflectance curve (200) retrieved,
to identify a pixel intensity difference between the reflectance curve prestored in the memory compared to the multiple spectral image captured.

7. The monitoring system of claim 6, wherein
in response to the pixel intensity difference identified is a predetermined value,
the analyzer module is operable to determine if the object in the multiple spectral image captured is an organ of a human.

8. The monitoring system of claim 7, wherein the organ of the human is a skin of the human.

9. The monitoring system of claim 5, wherein
the analyzer module is operable to
retrieve a reflectance curve prestored in a memory,
sample at least one point of reflectance within a spectral range of the multiple spectral image captured, and
compare the at least one point of reflectance sampled against a spectral range on the reflectance curve retrieved, the spectral range being a same spectral range as the spectral range sampled,
to identify a type of object in the multiple spectral image captured by the imaging module.

10. The monitoring system according to claim 9, wherein
the analyzer module is operable to
sample the first point of reflectance and the second point of reflectance against the reflectance curve retrieved.

11. The monitoring system according to claim 3, wherein
the first point of reflectance and the second point of reflectance is within a spectral range of the single wavelength of the combined light ray.

12. The monitoring system according to claim 1, wherein the single wavelength of the combined light ray is within a near-infrared wavelength.

13. The monitoring system according to claim 1, wherein the imaging module further comprises a driver for driving each of the plurality of light sources.

14. The monitoring system according to claim 1, wherein the processing unit is a binary spatial partitioning.

15. The monitoring system according to claim 1, wherein the processing unit is a host controller in electronic communication with the imaging module.

16. The monitoring system according to claim 5, wherein the processing unit comprises the analyzer module.

17. The monitoring system according to claim 6, wherein the reflectance curve comprises spectral measurements of different objects.

18. A method of identifying objects within a passenger cabin of a motor vehicle, the method comprising:
executing a set of instructions prestored in a memory of a processing unit comprising:
combining light rays emitting from at least two light sources, each light source operating at a different spectral bandwidth, into a combined light ray having a single wavelength;
capturing a multiple spectral image of a passenger cabin; and
identifying an object captured in the multiple spectral image.

19. The method according to claim 18, wherein
the set of instructions for combining light rays emitted from at least two light sources into a combined light ray having a single wavelength comprises:
switching on the at least two light sources sequentially;
or
switching on the at least two light sources simultaneously.

20. The method according to claim 18, further comprising:
comparing at least two points of reflectance of the multiple spectral image captured against a reflectance curve retrieved from a memory of a processing unit, for identification of a type of object captured in the multiple spectral image.

21. The method according to claim 20, further comprising:
identifying a pixel intensity difference between the at least one points of reflectance of the multiple spectral image captured against the at least two points of reflectance the reflectance curve retrieved; and
determining the object is an organ of a human in response to the pixel intensity difference is a predetermined value.

22. The method according to claim 21, wherein the organ of the human is a skin of the human.

23. The method of according to claim 18, further comprising:
sampling at least one point of reflectance within a spectral range of the multiple spectral image captured; and
comparing the at least one point of reflectance sampled against at least one point of the reflectance curve retrieved within a spectral range the same as the spectral range sampled,
for identifying a type of object in the multiple spectral image captured.

24. A computer software product that includes a non-transitory storage medium readable by a processing unit, the non-transitory storage medium having stored thereon a set of instructions, comprising:
executing the set of instructions prestored in the memory of the processing unit, comprising:
combining light rays emitting from at least two light sources, each light source operating at a different spectral bandwidth, into a combined light rat having a single wavelength;
capturing a multiple spectral image of a passenger cabin; and
identifying an object captured in the multiple spectral image.

25. A computer software product according to claim 24, wherein the computer software product is stored on the non-transitory storage medium.
